(19) United States
(12) Patent Application Publication
(10) Pub. No.: US 2013/0190039 A1
(43) Pub. Date: Jul. 25, 2013

(54) SYSTEMS AND METHODS FOR REQUESTING AND RECEIVING SERVICE

(71) Applicants: Kyeong Cheol Lee, Irvine, CA (US); Sung Joon Oh, Fullerton, CA (US)

(72) Inventors: Kyeong Cheol Lee, Irvine, CA (US); Sung Joon Oh, Fullerton, CA (US)

(21) Appl. No.: 13/555,949

(22) Filed: Jul. 23, 2012

Related U.S. Application Data
(60) Provisional application No. 61/589,338, filed on Jan. 21, 2012.

(51) Int. Cl. H04W 88/04

(52) U.S. Cl. 455/552.1

(57) ABSTRACT

Systems and methods for requesting and receiving service that includes a table having an input code such as a Quick Response Code, a smartphone having an application which is utilized to read the input code on the table and which communicates with a computer server that communicates with a computer such as a tablet personal computer used by a provider of the service.

### CROSS REFERENCE TO RELATED APPLICATIONS

This application claims priority to U.S. Provisional Application No. 61/589,338 filed on Jan. 21, 2012, the entirety of which is incorporated herein by reference.

### FIELD OF THE INVENTION

The present disclosure generally relates to systems and methods of requesting and receiving service which utilize a smartphone and an input code and embodiments thereof.

### BACKGROUND OF THE INVENTION

QR Code (abbreviated from Quick Response Code) is a type of matrix barcode (or two-dimensional code) first designed for the automotive industry. More recently, the system has become popular outside the industry due to its fast readability and large storage capacity compared to standard UPC barcodes. The code consists of black modules (square dots) arranged in a square pattern on a white background. The information encoded can be made up of four standardized kinds (“modes”) of data (numeric, alphanumeric, byte/binary, Kanji), or through supported extensions, virtually any kind of data.

Unlike the old bar code that was designed to be mechanically scanned by a narrow beam of light, the QR code is detected as a 2-dimensional digital image by a semiconductor image sensor and is then digitally analyzed by a programmed processor. The processor locates the three distinctive squares at the corners of the image, and normalizes image size, orientation, and angle of viewing, with the aid of a smaller square near the fourth corner. The small dots are then converted to binary numbers and validity checked with an error-correcting code.

Formerly confined to industrial uses, they have in recent years become common in consumer advertising and packaging, because the dissemination of smartphones has put a barcode reader in everyone's pocket for the first time. As a result, the QR code has become a focus of advertising strategy, since it provides quick and effortless access to the brand's website. Beyond mere convenience to the consumer, the importance of this capability is that it increases the conversion rate (that is, increase the chance that contact with the advertisement will convert to a sale), by coaxing qualified prospects further down the conversion funnel without any delay or effort, bringing the viewer to the advertiser's site immediately, where a longer and more targeted sales pitch may continue. Although initially used to track parts in vehicle manufacturing, QR Codes are now used over a much wider range of applications, including commercial tracking, product/loyalty marketing, and in-store product labeling. It can also be used in storing personal information for use by government.

There is an increasing prevalence of smarphones and QR Codes and input codes in general. However, there does not exist a convenient and easy system and method for requesting and receiving service from a service provider utilizing a smartphone of a user to read an input code such as a QR Code. Thus, there exists a need in the art for such a system and method.

### SUMMARY OF THE INVENTION

In an embodiment, the systems and methods of the present disclosure include a table having an input code, a smartphone having an application which is utilized to read the input code on the table and which communicates with a computer server that communicates with a computer including a tablet personal computer used by a provider of the service. The input code may be a QR Code, or an alphanumeric number. Alternatively, the input may be made by Near Field Communication. In a further embodiment, the system of the present disclosure provides for two way communication between a requester of the service and the service provider. In additional embodiments, the service provider may be a restaurant or a hotel or an airline. Alternatively, a tablet personal computer used by a service provider communicates with a Point of Sale (POS) system. In another embodiment, the service provider receives at least one order from a menu provided by the application of the smartphone. Further alternatively, the service receives and answers at least one question from a user at the table. The table may be a table in a class room or a table in a karaoke business establishment.

The present disclosure also relates to methods for requesting service having the steps of making an input of via an input code located on a table into a smartphone by a user; wherein the smartphone reads said input code and communicates with a computer server that communicates with a computer including a tablet personal computer used by a service provider.

### BRIEF DESCRIPTION OF THE DRAWINGS

FIG. 1 is a diagram of illustrating an embodiment of the present system for requesting and receiving service.

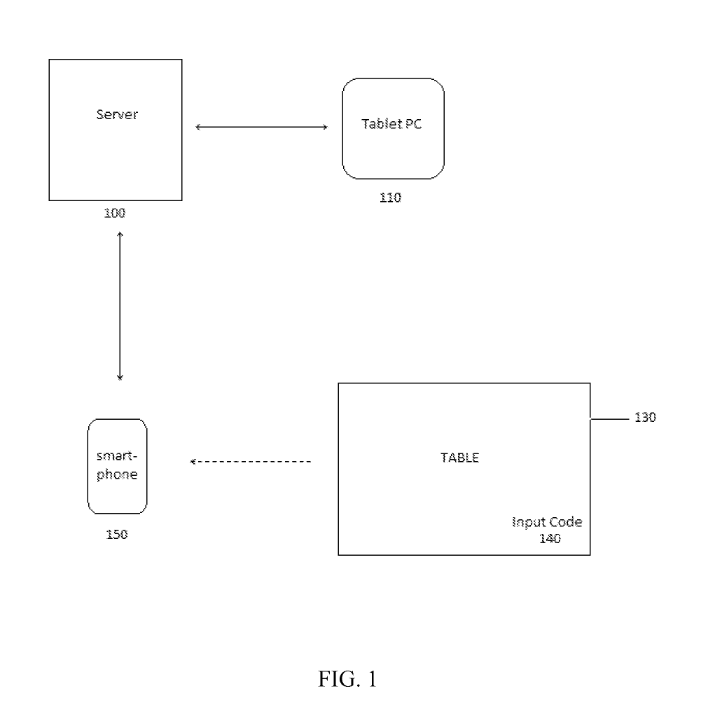

### DETAILED DESCRIPTION OF THE INVENTION

A system for requesting and receiving service in accordance with the present disclosure includes a table 130 having an input code 140, a smartphone 150 having an application which is utilized to read the input code on the table and which communicates with a computer server 100 that communicates with a computer including a tablet personal computer 110 used by a provider of the service.

The input code, as described herein is any type of a code, number or a series of numbers or any such indicator that is capable of being read by or input into a smartphone. In one embodiment, such a code is a Quick Response (QR) Code. QR Code is a type of a matrix barcode or a two-dimensional bar code. A QR Code may be scanned by a camera located on a smartphone of a user. It is also within the scope and content of the present disclosure that an input code such as a QR Code may also be scanned by a camera of a tablet computer or any other portable electronic device that may be able to read an input code. More often, because a smartphone is carried by most users such as patrons of a business establishment like a restaurant or hotel, it is a user's smartphone that will be used to scan a QR Code, or a bar code or other input codes to begin the process of requesting service from service provider. Therefore, in one embodiment, a user's smartphone scans a QR Code. However, it is also within the scope and content of the present disclosure to include other portable computer devices such as touch based internet enabled MP3 music players such as APPLE® IPOD® TOUCH®, that may be used to scan and read a QR Code.

After a QR Code has been scanned by a device that can be used to scan a QR Code such as a smartphone, a resident application (or “app”) is used to deciphers the code. An app which can be downloaded onto a smartphone such as APPLE® IPHONE® from APPLE® APP STORE® is superior to a system which makes a URL web page of a service provider appear on the internet browser of the smartphone. A webpage of a service provider is usually designed after much time and financial cost has been spent from design and implementation. An app on a smartphone which has been downloaded on a user's smartphone incurs no cost to a service provider such as a restaurant or hotel because a user can download the app from a marketplace such as the APPLE® APP STORE® for free or for a fee. In fact, a designed webpage is not actually necessary for a service provider or business establishment because the same app can be downloaded for a computer used by the service provider.

In one embodiment of the presently described system, the computer used by a service provider is a tablet personal computer such as APPLE® IPAD®. A service provider may download the same app, or modified for a tablet personal computer such as APPLE® IPAD® and receiving service requests from a user that scans a QR Code or other input code located on a table with his smartphone. Such an app is not limited to a tablet personal computer such as APPLE® IPAD® because desktop or laptop computers such as APPLE MAC increasingly allowing running of smartphone or tablet PC style apps. Thus, a service provider may use a traditional desktop computer with a separate monitor or even a laptop computer and run the same app which is on a user or patron's smartphone.

A smartphone's reading of the code by the application begins the process that allows communication with a computer server that may establish or already is in communication with a computer such as a tablet computer of a service provider in the presently described systems. A service provider can establish communications with a user of the smartphone by also scanning an input code to be read by an app on a computer device of a service provider. Or a service provider may connect by other means with the smartphone of a user by a computer server and a service provider's computer does not necessarily have to run the same app that runs on the user's smartphone. A designed software program that is different from the app running on a user's smartphone can conceivably be used as long as there is communications that can be established between a smartphone of user and a computer of a service provider. In sum, once a QR Code has been scanned by a user then the line of communications is open with a provider of a service.

An example of such as service provider is a restaurant. For this service provider, a user scans a QR Code that is located at the table he is seated. Then via an application on his smartphone, communications is established with the restaurant who may provide a menu or other information to the patron. With his smartphone, the patron may order items or request later for more service, such as asking for more beverage, more menu items, ask for clean up of spilled food or beverage or asking for the bill.

Another example of a service provider is a hotel or a motel. In a hotel's restaurant, a user or requester of a service will use his smartphone to scan an input code such as a QR Code located on a table in a restaurant as described above. For a guest room in a hotel, a QR Code may be located on any table or other convenient location in a room of a hotel such as a bedside table next to the telephone. Once a code is scanned and read by an app on a guest's smart phone in a hotel room communications can be established with the provider of service which in this case is the hotel. A guest may request room service, ask for the bill, or communicate with hotel management by a texting feature of an app already downloaded onto a guest's smartphone.

A service provider may use, among other devices, a tablet personal computer, to communicate with a requester of a service who scans an input code such as a QR Code. A tablet personal computer may also have an app installed that may be used to communicate with a patron's smartphone via a computer server. In one embodiment, the tablet computer may function as Point of Sale (POS) machine. In another embodiment, the tablet computer may connect to a separate computer that may function as a POS machine. With a provided application on the tablet computer, the service provider may conduct checkout transactions so that a patron can pay for the provided services in one embodiment.

In further embodiments, an input code located on a table may be an alphanumeric number, or a one dimensional barcode, which can alternatively entered into or read by a reading device such as a smartphone or a tablet personal computer. A particular table can have one input code or have more than one input code. In a typical embodiment, there will be one input code, such as a QR Code, at one table. However, it is also within the scope and content of the present discosure to have a QR Code at a table per seated restaurant patron.

Alternatively, an input may be made by a user or requester of service by Near Field Communication. Near field communication (NFC) is a set of standards for smartphones and similar devices to establish radio communication with each other by touching them together or bringing them into close proximity, usually no more than a few centimeters. Thus, contactless transactions, data exchange, and simplified setup of more complex communications such as Wi-Fi. With an NFC enabled smartphone, a user may bring his smartphone near an input activator or code which is located on a table at an establishment such as a restaurant or hotel. An app which is tailored to NFC enabled smartphones and tablet personal computers is hereby indicated as being within the scope and content of the present disclosure. Such an app may be installed on a user's smartphone and tablet personal computer or a service provider's tablet personal computer, or desktop computer or laptop computer or computer terminal as provided supra in case of when an input code is a QR Code.

In another embodiment, a service provider within the scope and content of the present disclosure may be an airline. To receive service from an airline in an airplane, a passenger can scan an input code such as a QR Code, located on a tray table. Each tray table can have a unique QR Code. Once the QR Code is scanned by a user's smartphone, communications can be established with the flight attendants on the airplane. The passenger may request that a flight attendant come by or may simply request service, such as bringing a beverage to the seated passenger.

It is also within the scope and content of the present disclosure, another embodiment, for there to be established two way communications from the requester of service and the service provider. Thus, instead of just one way communication from a user such as ordering a menu item, a service provider, alternatively possessing a tablet computer or another digital device such as a tablet personal computer, laptop computer, desktop computer or another computer terminal, communicate with a requester of service by sending of messages such as text messages provided with the established link after scanning of a QR Code. Thus, once a QR Code has been scanned and read by a device of a user, patron, or a passenger, a service provider may initiate communications. Such communications is facilitated by a smartphone or tablet app that can downloaded onto a smartphone of a passenger. The app can be an airline specific app or an app that can be useful more multiple airlines but can be specifically selected when an input code such as a QR Code is initially scanned by a passenger.

A requester of service may want to have a question answered. And in this case, once an input code such as a QR Code is scanned or input made by Near Field Communication, the service provider is alerted to the established communications and receives a question. The service provider may then communicate an answer without having to physically report to the location of the requester of service. In the case of inside an airplane, a flight attendant does not have to physically report to the seated passenger. A passenger may be prohibited from moving about the cabin but flight attendants may still move about in the airplane during different times in a flight. And during these times, as an example, the presently described two way communications may saves time and increases efficiency thus not only for the requester of service but also for the service provider.

In another embodiment, a table having an input code such as QR Code may be a table in a class room. A user or requester of service in this case is a student. A student can log in or establish communication by entry of a provided input code at his desk or table such as by scanning a QR Code with his smartphone. Then a question may be asked by a student to the provider of service, such as in this case, a teacher or an instructor. There are situations where a shy student may be reluctant to ask a question by raising his hand in front of the entire class, but may be willing to ask via his smartphone after scanning a QR Code at his desk. The instructor can then see the question or questions from one or more students and can provide an answer by communication directly with the student via the instructor's digital device such as a table personal computer or smart phone. Thus, a two way communication is made possible with the student and the teacher. Alternatively, communication via digital devices may be one way. After the student asks a question with his smartphone, a teacher may simply address the entire class with this physical voice.

In another embodiment, a table within the scope and content of the present disclosure may be a table in a karaoke bar/room. A patron may scan a QR Code located at the establishment and receive service from the owner of the karaoke bar/room. Similar to a restaurant situation, the owner may have two way communications with a patron once communications is established with the initial scanning of a QR Code.

The present disclosure also generally relates to methods of requesting service. These methods comprise the steps of making an input via an input code located on a table into a smartphone by a user wherein a smartphone reads the input code and communicates with a computer server that communicates with a tablet personal computer used by a service provider. Similar to the present described systems, the present methods relates to alternatively embodiments where an input code is a QR Code, alphanumeric code, and input is made by Near Field Communication. Alternatively for the present methods, two way communications is made between a service provider and a requester of service, tablet personal computer is used as a POS system device, an order is made from a menu item by a requester of service and a service provider receives and answers at least one question from a user at a table. In a further embodiment for the present methods, the table is a table in a class room or a table in a karaoke bar or room.

Unless otherwise indicated, all numbers expressing quantities of ingredients, properties such as lengths or widths, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

1. A system for requesting and receiving service comprising a table with an input code, a smartphone having an application which is utilized to read said input code on said table and which communicates with a computer server that communicates with a computer used by a provider of said service.

2. The system of claim 1, wherein said input code is a QR Code.

3. The system of claim 1, wherein an input by said smartphone is made by Near Field Communication.

4. The system of claim 1, wherein said input code is an alphanumeric number.

5. The system of claim 1, wherein said computer used by a provider of said service is a tablet personal computer.

6. The system of claim 1, wherein said system provides two way communication between a requester of said service and said service provider.

7. The system of claim 1, wherein said service provider is a restaurant.

8. The system of claim 1, wherein said service provider is an airline.

9. The system of claim 5, wherein said tablet personal computer communicates with a Point of Sale (POS) system.

10. The system of claim 1, wherein said service provider receives of at least one order from a menu provided by said application of said smartphone.

11. The system of claim 1, wherein said service receives and answers at least one question from a user at said table.

12. The system of claim 1, wherein said table is a table in a class room, karaoke bar/room.

13. A method of requesting service comprising the steps of:
making an input of via an input code located on a table into a smartphone by a user; wherein said smartphone reads said input code and communicates with a computer server that communicates with a computer used by a service provider.

14. The method of claim 13, wherein said input code is a QR Code.

15. The method of claim 13, an input by said smartphone is made by Near Field Communication.

16. The method of claim 13, wherein said input code is an alphanumeric number.

17. The method of claim 13, wherein said computer used by a provider of said service is a tablet personal computer.

18. The method of claim 13, wherein said system provides two way communication between a requester of said service and said service provider.

19. The method of claim 13, wherein said service provider is a restaurant.

20. The method of claim 13, wherein said service provider is an airline.

21. The method of claim 17, wherein said tablet personal computer communicates with a Point of Sale (POS) system.

22. The method of claim 13, wherein said service receives at least one order from a menu provided on said application of said smartphone.

23. The method of claim 13, wherein said service receives and answers at least one question from a user at said table.

24. The method of claim 13, wherein said table is a table in a class room or karaoke bar/room.
